(19) United States
(12) Patent Application Publication
(10) Pub. No.: US 2004/0011169 A1
(43) Pub. Date: Jan. 22, 2004

(54) Apparatus for trimming the dome area of a wide mouth blow molded plastic container

(75) Inventors: Harold James Marshall, Forest, VA (US); William Storrs Reynolds, Lynchburg, VA (US)

Correspondence Address: FOLEY AND LARDNER, SUITE 500, 3000 K STREET NW, WASHINGTON, DC, 20007, US

(73) Assignee: DELAWARE CAPITAL FORMATION, INC.

(21) Appl. No.: 10/199,033

(22) Filed: Jul. 22, 2002

(51) Int. Cl. B26D 1/00

(52) U.S. Cl. 83/13; 83/946; 30/495

(57) ABSTRACT

The present invention includes an apparatus and method for trimming the dome of a container comprising at least one trimming station having a plurality of guide rollers and a knife, and a rotation guide. The apparatus is adapted so that the container is in contact with the rotation guide and at least two of the guide rollers during trimming.

### FIELD OF THE INVENTION

The present invention is directed generally to machinery for plastic container production and specifically to an apparatus for trimming the dome area of a blow molded plastic container.

### BACKGROUND OF THE INVENTION

Thin-walled plastic containers, such as bottles filled with milk, juice, and other liquids are generally manufactured by blow molding. A typical as-blown wide mouth blow molded container 100 is illustrated in FIG. 1. The container 100 comprises two portions, a wide mouth container portion 102 and a dome portion 104 above the designed opening of the wide mouth container portion 102. Separating the wide mouth container portion 102 and the dome portion 104 is a radially inwardly extending circumferential trim line groove 106. The trim line groove line 106 is molded into the container 100 at the trim line and serves to guide the trimming knife at a right angle to the axis of the container 100.

The dome portion 104 is required for the blow molding process only and is typically reclaimed after being severed from the wide mouth container portion 102. Conventionally, the dome portion 104 includes a guide feature 108 to assist in guiding and/or driving the container through the trimming process. The dome portion 104 also includes a preform neck portion 110 which is affixed to the blow molding machine when the container 100 is blown. Typically, the preform neck portion 110 may include screw threads (not shown).

For the production of wide mouth containers, the dome portion 104 is ancillary to the wide mouth container portion 102 and must be removed after the blow molding operation. In order to manufacture a container which seals properly, the dome portion 104 must be removed in such a way as to provide a smooth, clean cut opening on the container. Conventionally, removal of the dome portion 104 is accomplished by inserting a knife into the trim line groove 106 in the container 100 and rotating the container 100. Known methods of severing the dome portion 104 include the use of fixed and rotating knives.

Fixed knife methods generally comprise passing a rotating container along a long fixed knife. The container is supported and rotated by a moving belt opposite the fixed knife. Optionally, the knife is heated to aid in cutting. Although this method works, it is only suitable for low tolerances. This is because the container is only supported at two points and tends to wobble. Thus, a relatively uneven cut surface is formed.

In rotating knife methods, both the container and the knife rotate. Typically, a drive wheel supports and rotates the container on one side while a rotating knife supports and cuts the container on the opposite side. The rotating knife systems have the advantage that they are smaller and take up less floor space in the manufacturing plant than the fixed knife systems. However, as in the fixed knife system, the container is only supported in two places. Thus, the container can wobble, resulting in an uneven cut surface.

Wide mouth blow molded containers require a smooth, clean cut surface to ensure a good seal. However, conventional methods for removing the dome portion of blow molded containers generate significant wobble which often leaves an uneven cut surface on the container. Therefore, it would be advantageous to have an apparatus for cutting the dome portion off a blow molded container which reduced wobble and consistently produced smooth, clean cuts.

### SUMMARY OF THE INVENTION

The present invention includes an apparatus for trimming the dome of a container comprising at least one trimming station having a plurality of guide rollers and a knife, and a rotation guide, wherein the apparatus is adapted so that the container is in contact with the rotation guide and at least two of the guide rollers during trimming.

In a further aspect of the invention, the apparatus further comprises a trimmer wheel.

In a further aspect of the invention, the at least one trimming station is one of a plurality of trimming stations mounted to a trimmer wheel.

In a further aspect of the invention, the apparatus further comprises an infeed mechanism to guide an incoming container into the trimmer wheel.

In a further aspect of the invention, the infeed mechanism is selected from the group consisting of a feed screw, a starwheel, guides and combinations thereof.

In a further aspect of the invention, the at least one trimming station has a first guide roller and a second guide roller.

In a further aspect of the invention, the first guide roller and the second guide roller are mounted approximately 120 degrees apart.

In a further aspect of the invention, the knife comprises having a flat edge on one side.

In a further aspect of the invention, the at least one trimming station is adapted so that the flat edge of the knife is towards the container when the container enters the at least one trimming station.

In a further aspect of the invention, the apparatus further comprises a stationary gear.

In a further aspect of the invention, wherein the at least one trimming station further comprises a pinion gear.

In a further aspect of the invention, the at least one trimming station is mounted to a trimmer wheel and wherein the knife is mounted on a shaft affixed to the pinion gear.

In a further aspect of the invention, the apparatus is adapted so that when the trimming wheel rotates, the pinion gear orbits around the stationary gear.

In a further aspect of the invention, wherein the knife rotates as the pinion gear rotates.

In a further aspect of the invention, the knife is adapted so that the circumferential speed of the knife is different than the circumferential speed of the container.

In a further aspect of the invention, the knife is adapted to penetrate the container approximately 3 mm.

In a further aspect of the invention, the rotation guide includes teeth.

In a further aspect of the invention, the teeth are adapted to make the container rotate.

In a further aspect of the invention, the apparatus is adapted so that the container makes at least one full rotation during trimming.

In a further aspect of the invention, the apparatus further comprises an adjacent starwheel to transfer the container to a subsequent machine.

In a further aspect of the invention, the apparatus further comprising trimmed dome guides to direct the dome out of the apparatus.

In a further aspect of the invention, wherein the guide rollers are shaped to fit a feature molded in the container.

In a further aspect of the invention, the knife is adapted to fit in a groove in the container while cutting.

A method of trimming containers comprising the steps of feeding a container to an apparatus including at least one trimming station having a plurality of guide rollers and a knife and a rotation guide, wherein the apparatus is adapted so that the container is in contact with the rotation guide and at least two of the guide rollers during trimming and trimming the container with the knife.

In a further aspect of the invention, the step of trimming comprises rotating the knife.

In a further aspect of the invention, wherein rotating the knife comprises rotating a knife shaft mounted to a pinion gear.

In a further aspect of the invention, the step of trimming comprises penetrating the knife approximately 3 mm into the container.

In a further aspect of the invention, the step of trimming comprises rotating the container.

In a further aspect of the invention, the container rotates a minimum of at least one full rotation during trimming.

In a further aspect of the invention, rotating the container comprises contacting the container with teeth on the rotation guide.

In a further aspect of the invention, the knife rotates with a circumferential speed different than the circumferential speed of the container.

In a further aspect of the invention, the step of trimming comprises orbiting the trimming station about a stationary gear.

In a further aspect of the invention, the method further comprises a step of transferring the container to an adjacent starwheel.

In a further aspect of the invention, the method further comprises the step of guiding a dome trimmed from the container to a discharge chute.

In a further aspect of the invention, the dome is directed away from a trimmer wheel with trimmed dome guides.

An apparatus for trimming a domed portion of a container comprising at least one trimming station having at least two contact points and a knife and a rotation guide having a contact point, wherein the apparatus is adapted so that the container is in contact with the at least two contact points and the guide contact point during trimming.

### BRIEF DESCRIPTION OF THE DRAWINGS

The foregoing and other features, aspects and advantages of the present invention will become apparent from the following description, appended claims and the exemplary embodiments shown in the drawings, which are briefly described below. It should be noted that unless otherwise specified like elements have the same reference numbers.

FIG. 1 is a side view of a typical blow molded container.

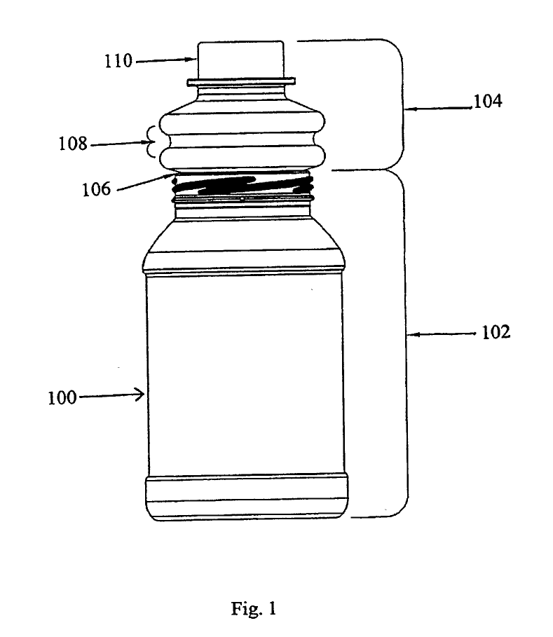

FIG. 2 is a schematic illustration of the prefered embodiment of the invention.

FIG. 3 is a detailed view of a portion of FIG. 1.

FIG. 4 is a sectional view along line AA in FIG. 3.

FIG. 5 is a sectional view along line BB in FIG. 3.

### DETAILED DESCRIPTION OF THE PREFERRED EMBODIMENTS

The present inventors have discovered that supporting a wide mouth blow molded container at more than two locations while cutting off the dome portion results in a significantly better and reproducible cut surface. By supporting the container in more than two locations, wobble of the container can be significantly reduced. In addition, the inventors have discovered that use of this invention allows for greater cutting speeds and container throughput. Preferably, the container is supported by a guide rail and two guide rollers. However, additional guide rollers may be added for improved stability.

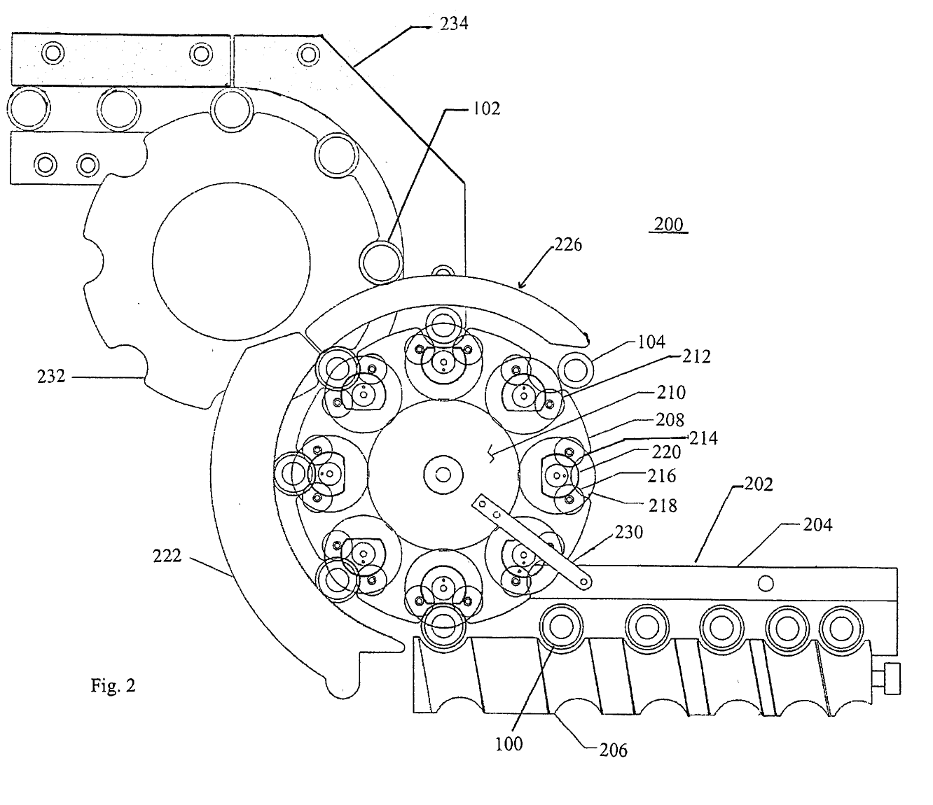

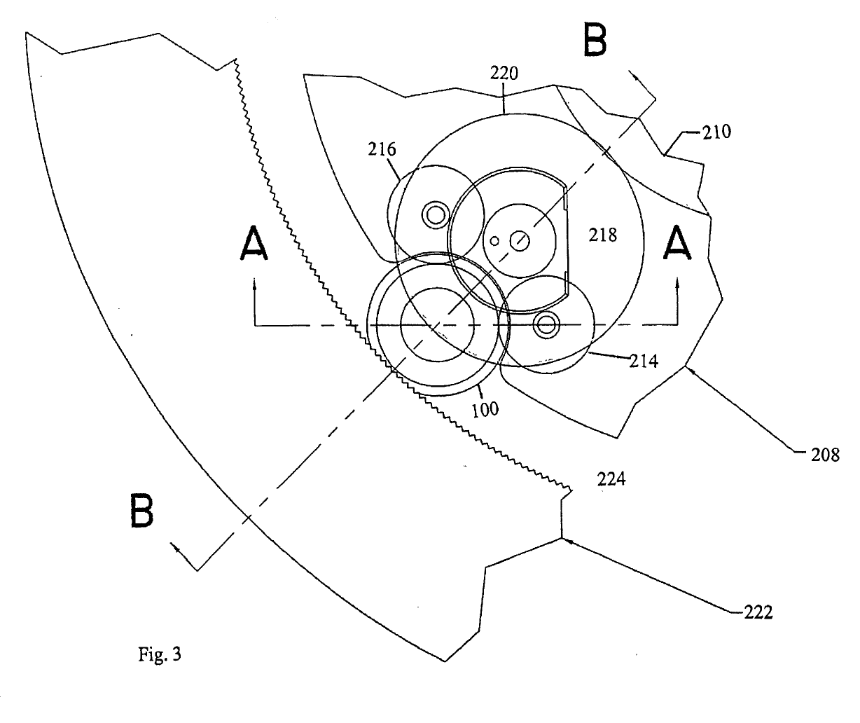

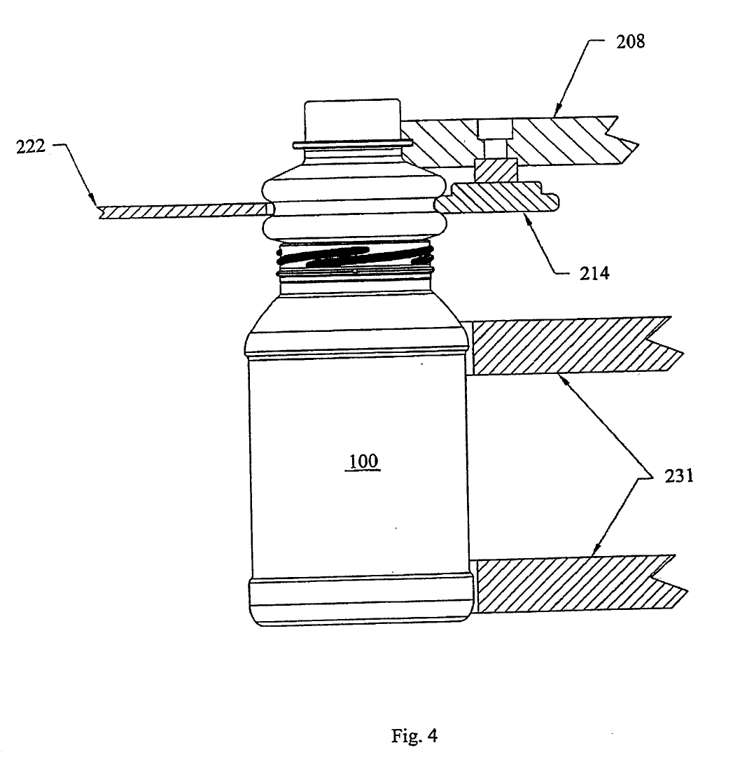

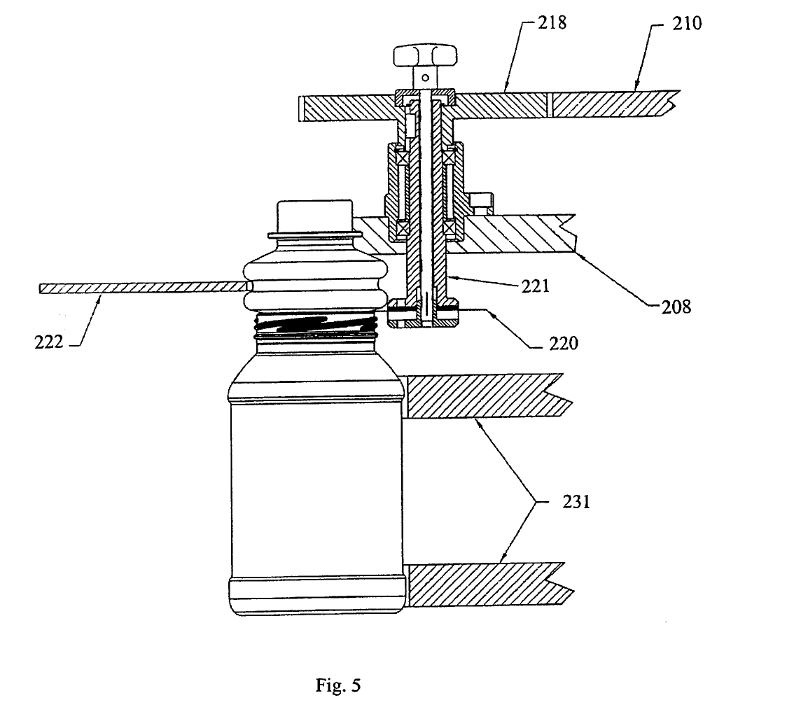

FIG. 2 is a schematic illustration of the preferred embodiment of the invention while FIGS. 3-5 are detailed and sectional views of the first embodiment. The dome trimming apparatus 200 includes an infeed mechanism 202. In one embodiment of the invention, the infeed mechanism 202 includes an infeed guide 204 and an infeed screw 206. However, the infeed mechanism 202 may include a starwheel (not shown), an infeed screw 206 or infeed guides 204 either singly or in combination.

The infeed mechanism 202 presents a blow molded container 100 in a controlled orientation to one of a plurality of trimming stations 212 arrayed about a trimmer wheel 208. Each trimming station 212 includes a plurality of guide rollers. In the preferred embodiment of the invention, each trimming station 212 includes two guide rollers 214, 216. Preferably the guide rollers 214, 216 are mounted approximately 120 degrees apart. If additional guide rollers are used, the angle between rollers should be decreased.

In addition to the guide rollers 214, 216, the trimming stations 212 include a pinion gear 218. The pinion gear 218 is in meshing contact with a stationary gear 210 whose center corresponds to the rotational axis of the trimmer wheel 208. As the trimmer wheel 208 rotates, the trimming stations 212 orbit around the stationary gear 210.

Affixed to the pinion gear 218 is one end of a knife shaft 221. Affixed to the other end of the knife shaft 221 is a knife 220. As the trimming stations 212 orbit about the stationary gear 210, the pinion gear 218 rotates, rotating the knife shaft 221 and the knife 220.

Generally, the knife 220 is disc shaped. However, in the preferred embodiment of the invention, the knife 220 has a flat resulting in a “D” shaped blade.

As a container 100 is presented to the trimmer wheel 208, the two rollers 214, 216 of the trimming station 212 and an rotation guide 222 position the container 100. This creates three points of contact, which stabilizes the container 100 during trimming. Preferably, when the container 100 enters the trimmer wheel 208 the flat side of the knife 220 is towards the container 100. This allows the container 100 to contact the guide rollers 214, 216 before the knife penetrates the container 100.

Preferably, the rotation guide 222 has a series of teeth that grab the dome portion 104 of the container 100. As the trimmer wheel 208 rotates, the container 100 also rotates due to its contact with the teeth on the rotation guide 222. Thus, both the container 100 and the knife 220 rotate as the trimmer wheel 208 rotates.

Preferably, the circumferential speed of the knife 220 is designed to be different than the circumferential speed of the container 100. This speed differential produces shearing action and reduces cutting forces, i.e., the forces required to cut the container. Further, in order to ensure that the dome portion 104 is completely severed from the container 100, the container 100 rotates a minimum of one full rotation. While cutting, the knife 220 typically penetrates 3 mm into the container 100. However, the penetration depth may be varied, the optimal depth being determined experimentally.

Once the dome 104 is severed from the container 100, the container 100 continues in the path of the trimmer wheel 208 via a container starwheel 231. It is then transferred to an adjacent transfer starwheel 232. The transfer starwheel 232, with or without additional transfer guides 234, can transfer the container 100 to another operation or onto a conveyor. The trimmed dome portion 104 is guided along a trimmed dome guide 226 to a discharge chute (not shown).

To add stability to the apparatus, the preferred embodiment includes an anti-rotation arm 230. Preferably, the anti-rotation arm connects the stationary gear 210 to the infeed mechanism 202.

In a second embodiment of the invention, the stationary gear 210 is replaced with a rotary gear (not shown). Preferably, the rotary gear is driven by an independent drive mechanism (not shown). However, the rotary gear may be connected to the same drive mechanism as the trimmer wheel 208 via gears, belts, chains or any other known technique. Use of a rotary gear rather than a stationary gear 210 increases the complexity of the dome trimming apparatus 200, however it gives greater control over the apparatus 200. That is, by independently controlling the speed of the rotary gear, the speed of the knife 220 may be independently controlled. Without independent control of the rotary gear, the speed of the knife 220 must be controlled by setting the pitch diameter of either the pinion gear 218 or the stationary gear 210.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. It is intended that the scope of the invention be defined by the claims appended hereto, and their equivalents.

What is claimed is:

1. An apparatus for trimming the dome of a container comprising:
at least one trimming station having a plurality of guide rollers and a knife; and
a rotation guide,
wherein the apparatus is adapted so that the container is in contact with the rotation guide and at least two of the guide rollers during trimming.

2. The apparatus of claim 1, further comprising a trimmer wheel.

3. The apparatus of claim 2, wherein the at least one trimming station is one of a plurality of trimming stations mounted to a trimmer wheel.

4. The apparatus of claim 1, further comprising an infeed mechanism to guide an incoming container into the trimmer wheel.

5. The apparatus of claim 4, wherein the infeed mechanism is selected from the group consisting of a feed screw, a starwheel, guides and combinations thereof.

6. The apparatus of claim 1, wherein the at least one trimming station has a first guide roller and a second guide roller.

7. The apparatus of claim 6, wherein the first guide roller and the second guide roller are mounted approximately 120 degrees apart.

8. The apparatus of claim 1, wherein the knife comprises having a flat edge on one side.

9. The apparatus of claim 8, wherein the at least one trimming station is adapted so that the flat edge of the knife is towards the container when the container enters the at least one trimming station.

10. The apparatus of claim 1, further comprising a stationary gear.

11. The apparatus of claim 10, wherein the at least one trimming station further comprises a pinion gear.

12. The apparatus of claim 11, wherein the at least one trimming station is mounted to a trimmer wheel and wherein the knife is mounted on a shaft affixed to the pinion gear.

13. The apparatus of claim 12, wherein the apparatus is adapted so that when the trimming wheel rotates, the pinion gear orbits around the stationary gear.

14. The apparatus of claim 13, wherein the knife rotates as the pinion gear rotates.

15. The apparatus of claim 14, wherein the knife is adapted so that the circumferential speed of the knife is different than the circumferential speed of the container.

16. The apparatus of claim 15, wherein the knife is adapted to penetrate the container approximately 3 mm.

17. The apparatus of claim 1, wherein the rotation guide includes teeth.

18. The apparatus of claim 17, wherein the teeth are adapted to make the container rotate.

19. The apparatus of claim 18, wherein the apparatus is adapted so that the container makes at least one full rotation during trimming.

20. The apparatus of claim 1, further comprising an adjacent starwheel to transfer the container to a subsequent machine.

21. The apparatus of claim 1, further comprising trimmed dome guides to direct the dome out of the apparatus.

22. The apparatus of claim 1, wherein the guide rollers are shaped to fit a feature molded in the container.

23. The apparatus of claim 1, wherein the knife is adapted to fit in a groove in the container while cutting.

24. A method of trimming containers comprising the steps of:
feeding a container to an apparatus including at least one trimming station having a plurality of guide rollers and a knife and a rotation guide, wherein the apparatus is adapted so that the container is in contact with the rotation guide and at least two of the guide rollers during trimming; and
trimming the container with the knife.

25. The method of claim 24, wherein the step of trimming comprises rotating the knife.

26. The method of claim 25, wherein rotating the knife comprises rotating a knife shaft mounted to a pinion gear.

27. The method of claim 25, wherein the step of trimming comprises penetrating the knife approximately 3 mm into the container.

28. The method of claim 27, wherein the step of trimming comprises rotating the container.

29. The method of claim 28, wherein the container rotates a minimum of at least one full rotation during trimming.

30. The method of claim 28, wherein rotating the container comprises contacting the container with teeth on the rotation guide.

31. The method of claim 28, wherein the knife rotates with a circumferential speed different than the circumferential speed of the container.

32. The method of claim 24, wherein the step of trimming comprises orbiting the trimming station about a stationary gear.

33. The method of claim 24, further comprising a step of transferring the container to an adjacent starwheel.

34. The method of claim 24, further comprising the step of guiding a dome trimmed from the container to a discharge chute.

35. The method of claim 34, wherein the dome is directed away from a trimmer wheel with trimmed dome guides.

36. An apparatus for trimming a domed portion of a container comprising:
at least one trimming station having at least two contact points and a knife; and
a rotation guide having a contact point,
wherein the apparatus is adapted so that the container is in contact with the at least two contact points and the guide contact point during trimming.

37. The apparatus of claim 36, further comprising a trimmer wheel and a rotary gear.

38. The apparatus of claim 37, wherein the trimmer wheel and the rotary gear are independently controlled.

39. A method of trimming containers comprising the steps of:
feeding a container to an apparatus including at least one trimming station having at least two contact points and a knife and a rotation guide having a contact point, wherein the apparatus is adapted so that the container is in contact with the at least two contact points and the guide contact point during trimming; and
trimming the container with the knife.

40. The method of claim 39, wherein the step of trimming the container comprises independently controlling a trimmer wheel and a rotary gear.
